(19) United States
(12) Patent Application Publication
(10) Pub. No.: US 2003/0163423 A1
(43) Pub. Date: Aug. 28, 2003

(54) Method and apparatus for secure electronic payment

(75) Inventor: Erik Holst-Roness, Geneva (CH)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Teleglobal International Ltd.

(21) Appl. No.: 10/373,681

(22) Filed: Feb. 27, 2003

Related U.S. Application Data
(60) Provisional application No. 60/359,635, filed on Feb. 27, 2002.

(51) Int. Cl. G06F 17/60

(52) U.S. Cl. 705/40

(57) ABSTRACT

A method for providing a secure electronic payment for purchase of goods and services is disclosed. The method includes the steps of awaiting initiation by a user seeking a secure electronic payment token from a dispensing unit, contacting a server, upon initiation by the user and awaiting notification from the server that the dispensing unit is registered. The method also includes the steps of requesting a personal identification number from the user, forwarding the personal identification number and a value for the secure electronic payment token to the server, awaiting confirmation from the server and providing notification to the user whether a code associated with the secure electronic payment token has been activated.

### REFERENCE TO RELATED APPLICATIONS

This application claims priority of U.S. Provisional Patent Application Serial No. 60/359,635, filed on Feb. 27, 2002. The contents of the above application are hereby incorporated by reference.

### BACKGROUND OF THE INVENTION

1. Field of Invention

The present invention relates to electronic payment systems, where a user may conduct a transaction without the delivery or exchange of physical currency. In particular, the present invention is directed to methods and apparatuses for secure electronic payment were a payment mechanism is created, distributed and activated to purchase goods and/or services.

2. Description of Related Art

The use of credit and debt cards revolutionized commerce worldwide. Both types of payment systems allow a user to purchase goods and/or services without the physical outlay of cash. In particular, the emergence of fast and reliable worldwide networks has allowed for greater acceptance of the payment forms because verification of payment authority can be made at the time the commercial transaction is engaged. In addition, the appearance of on-line commerce through E-merchants has intensified the use of electronic payment systems since there is no physical connection between the parties to the transaction. However, the high overhead associated with traditional credit and debit card systems has caused problems with individual entities accepting and processing such electronic transactions. In addition, on-line access may also be prorated such that access to individual items may require a small payment that is below the traditional threshold for credit and debit cards being feasible. As such, many electronic payment systems have been proposed that seek to rectify these and other problems associated with large-scale payment systems.

One example of these prior art systems is discussed in U.S. Pat. No. 5,477,038 to Levine. The disclosure is directed to a method and apparatus for distributing currency by providing electronic access to pre-paid funds for cash or payment for goods and services. A card is issued to a customer with a value selectable by the customer, where the card has a magnetic strip with an encoded card number including the bank identification number (BIN) and an account number. When a customer purchases a card, the sales agent transmits to the central database computer that fills in the blanks in the database, activating the account. However, Levine does not disclose access to pre-paid funds by means other than a card and access is limited to a magnetic strip. Furthermore, the purchase of the card in the Levine reference is only through a sales agent.

Another exemplary disclosure is provided in U.S. Pat. No. 6,119,105 to Williams. It discloses a secure transmission of data provided from a customer computer system to a merchant computer system, and for the further secure transmission of payment information regarding a payment instrument from the merchant computer system to a payment gateway computer system. A certificate form must be completed in order to obtain a certificate that authorizes electronic transaction processing using an appropriate software program. Williams also discloses Virtual Point of Sale devices that can accept payment by credit card, debit card, electronic cash, electronic check, micro-payment or smart card. Although Williams discloses the secure communication for purchasing goods and services via credit card, it does not disclose that multiple cards can be consolidated to make a single purchase. Furthermore, Williams does not disclose using a bankcard to purchase a certificate through the automatic cash teller machine, wherein the certificate then allows a consumer to purchase goods and services. The certificate disclosed in Williams appears to be for the purpose of establishing a secure communication between the customer's computer system and the merchant's computer system.

Also exemplary of the prior art is U.S. Pat. No. 6,308,887 to Korman. Korman discloses an automated transaction machine which supports multiple destination transaction and a variety of communication protocols and/or message formats permitting any type of network-based kiosk-oriented product or service to be offered, including bill payment, real-time activated pre-paid phone card dispensing, loyalty cards for retail stores, smart card issuance and recharging, smart chip recharging (for the new pre-paid cellular phones and similar devices), customized and/or interactive advertising, event tickets, airline tickets, money orders, dispensing of postage stamps, paid or promotional coupons and gift certificates, worldwide web browser, charitable donations, etc. The user may also elect to receive a receipt for cash or credit towards purchases at a store. However, Korman does not disclose the purchase of a certificate through an electronic payment terminal or being notified by e-mail, based on a telephonic or electronic banking request, of a code and/or PIN for purchasing goods and services. Although Korman appears to disclose dispensing pre-paid phone cards, loyalty cards and smart cards from the network-based kiosk, the loyalty or smart cards do not appear to carry a value such that a consumer to may use the card to purchase goods and services.

However, absent from the prior electronic payment systems is a system that provides for a variety of methods for distributing the electronic payment mechanism to consumers, as most require the consumer go to a retail outlet or kiosk to obtain a card. In particular, the prior art fails to teach or suggest obtaining a certificate for use with an electronic payment system through an automatic cash teller machine or through an electronic payment terminal. Further, none of the prior art teaches or suggests notification of an alphanumeric code by e-mail by telephonic request or by request from an electronic bank website.

Thus, there is a need for an electronic payment mechanism that is flexible and may be used in a variety of settings. There is also a need for an electronic payment mechanism that is not constrained to a single format so that it can be applied to purchases at physical retail establishments and on-line retailers and to provide compensation for on-line activities.

### SUMMARY OF THE INVENTION

The present invention is directed to an electronic payment mechanism that involves pre-payment funds associated with an alphanumeric code that is protected by a personal identification code. The electronic payment mechanism, according to the present invention, involves a code that is available on a card, certificate or notified electronically. The alphanumeric code allows an individual, through a personal identification code, to purchase goods or services from merchants registered to accept the electronic payment mechanism as a payment mechanism. The invention is also directed to a method of preparing pre-printed cards and a method of distributing electronic payment mechanisms to consumers through a number of outlets. The outlets can be a retail outlet, an automatic teller machine, an electronic banking outlet, such as an e-bank, or an electronic payment terminal. The electronic payment code can also be received through e-mail by telephonic or electronic banking request or any other device capable of communicating securely with the electronic payment server.

According to one aspect of this invention, a method for providing a secure electronic payment for purchase of goods and services is disclosed. The method includes the steps of awaiting initiation by a user seeking a secure electronic payment token from a dispensing unit, contacting a server, upon initiation by the user and awaiting notification from the server that the dispensing unit is registered. The method also includes the steps of requesting a personal identification number from the user, forwarding the personal identification number and a value for the secure electronic payment token to the server, awaiting confirmation from the server and providing notification to the user whether a code associated with the secure electronic payment token has been activated.

Additionally, the method may be applicable to the use of a pre-printed card with an ascribed value and the personal identification number and the ascribed value would be forwarded to the server. In such an embodiment, the step of awaiting initiation by a user awaits the pre-printed card being swiped through a magnetic strip reader of the dispensing unit, or alternatively awaiting an interaction between the pre-printed card and the dispensing unit through at least one of optical bar code recognition, optical character recognition and transfer of digital information via a wireless communication mechanism. In addition to the forwarding of the personal identification number and a value for the secure electronic payment token to the server further, a currency measurement for the ascribed value, a merchant identifier and a machine identifier to the server may also be forwarded.

According to another embodiment, the secure electronic payment token is a certificate, the dispensing unit is an automatic teller machine and the value for the secure electronic payment token is requested from the user. In such an embodiment, the step of awaiting initiation by a user includes awaiting an insertion of a bank card into the automatic teller machine. Also, both the receipt of an authorization and the code associated with the secure electronic payment token may occur from the server, where the authorization is obtained by the server from a bank associated with the bank card. In this embodiment, the step of providing notification to the user may include printing the certificate with a printer contained within the automatic teller machine.

In an alternate embodiment, the secure electronic payment token is a certificate, the dispensing unit is a payment terminal and the method further includes requesting the value for the secure electronic payment token from the user. In such an embodiment, the awaiting initiation step occurs through awaiting a payment indication by the user on the payment terminal. Additionally, the receipt of an authorization and the code associated with the secure electronic payment token would occur from the server. Also, the certificate may be printed with a printer contained within the payment terminal.

Also, the dispensing unit may be an online banking site and the method would include requesting the value for the secure electronic payment token and information related to an account with the online banking site from the user. After a requester has entered the amount and a personal identification number into an e-banking web-page for transmission to the server for the secure electronic payment system, for example, the server assigns a code, activates the code, and returns a report of the code to the e-banking web-site for display on a web-page for the requester to see. The code may be noted or printed for further reference by the requester.

In another aspect of the invention, a secure electronic payment system for providing a secure electronic payment for purchase of goods and services is disclosed. The system includes first awaiting means for awaiting initiation by a user seeking a secure electronic payment token from a dispensing unit, contacting means for contacting a server, upon initiation by the user and second awaiting means for awaiting notification from the server that the dispensing unit is registered. The system also includes requesting means for requesting a personal identification number from the user, forwarding means for forwarding the personal identification number and a value for the secure electronic payment token to the server, third awaiting means for awaiting confirmation from the server and providing means for providing notification to the user whether a code associated with the secure electronic payment token has been activated.

These and other objects of the present invention will be described in or be apparent from the following description of the preferred embodiments.

### BRIEF DESCRIPTION OF THE DRAWINGS

For the present invention to be easily understood and readily practiced, preferred embodiments will now be described, for purposes of illustration and not limitation, in conjunction with the following figures:

FIG. 1 illustrates the process of purchasing a electronic payment card from a reseller, according to one embodiment of the present invention;

FIG. 2 illustrates the process of purchasing a electronic payment certificate from an Automatic Teller Machines (ATMs), according to one embodiment of the present invention;

FIG. 3 illustrates the process of purchasing a electronic payment certificate from an Payment Terminal (PT), according to one embodiment of the present invention;

FIG. 4 illustrates the process of purchasing a electronic payment certificate from an electronic banking establishment (E-Bank), according to one embodiment of the present invention;

FIG. 5 illustrates the overall process flow of obtaining and using the electronic payment mechanism, according to one embodiment of the present invention.

### DETAILED DESCRIPTION OF PREFERRED EMBODIMENTS

The present invention is directed to an electronic payment mechanism that involves pre-payment funds associated with an alphanumeric code that is protected by a personal identification code. The electronic payment mechanism, according to the present invention, involves a code that is available on a card, certificate or notified electronically. The alphanumeric code allows an individual, through a personal identification code, to purchase goods or services from merchants registered to accept the electronic payment mechanism as a payment mechanism.

The invention is also directed to a method of preparing pre-printed cards and a method of distributing electronic payment mechanisms to consumers through a number of outlets. The outlets can be a retail outlet, an automatic teller machine, or an electronic payment terminal. The electronic payment code can also be received through e-mail by telephonic or electronic banking request or any other device capable of communicating securely with the electronic payment server. Examples of such devices or media are instant messaging or short message service (SMS) to provide a secure link to the electronic payment server.

In order for an individual to interface the electronic payment mechanism with a electronic payment server, the electronic payment server requires the electronic payment code, Personal Identification Number (PIN), electronic payment card value, currency, merchant ID and machine ID. Once this information is transmitted to the electronic payment server, the code for the electronic payment card, certificate or electronic communication will be activated and the consumer and then use electronic payment mechanism to purchase goods and services from merchants registered to accept the electronic payment mechanism as a means of payment. The electronic payment mechanism requires a PIN in order to activate the code and thereby provide a secure means for the consumer to purchase goods.

The present invention is directed to a payment mechanism that combines several existent and separate aspects of technology and networks into unique system which can be implemented using computer or electronic hardware and software, and which can utilize computer networks, including the Internet. As discussed in sections above, there have been several types of electronic payment systems that have been developed, but those systems fail to provide the flexibility and other benefits of the present invention, as discussed below.

The electronic payment mechanism according to embodiments of the present invention involves pre-payment of an alphanumeric code, available from a variety of sources, that is protected by a personal code of identification, and that can be used to purchase goods or services from merchants registered to accept the electronic payment mechanism as a payment mechanism. The electronic payment mechanism of the present invention may be embodied in several configurations. Several of these configurations are discussed below and are divided into groups based on how the codes are distributed. The codes may be available on cards (pre-printed), certificates (printed on request) or advised electronically (e-mail, SMS, instant messaging, etc.).

With respect to pre-printed card preparation, the codes are generated randomly and non-sequentially through the electronic payment mechanism and linked to a random value and a currency. Thereafter, codes and accompanying information are dispatched to a card printer. The cards are printed with the code, currency and value displayed on the card front with matching information programmed on a magnetic strip on the reverse side of the card. The magnetic strip may also contain additional information relating to distribution as well as to identify the card as a specific electronic payment card to a magnetic strip reader.

With respect to distribution to the pre-printed cards, such distribution would most likely occur in retail outlets. The pre-printed cards may be packaged with a Stock Keeping Unit (SKU) and/or a Universal Product Code (UPC) so that they can be purchased at points-of-purchase. Additionally, such pre-printed cards may be distributed through mail order or other alternate purchase system.

As opposed to the use of pre-printed cards discussed above, distribution of codes and other data to consumers may occur through different channels that are responsive to a consumer's queries. While the distribution of the electronic payment mechanisms of the present invention can be through “bricks and mortar” retail outlets, other outlets are also available. These outlets include automatic cash teller machines (ATMs) or electronic payment terminals (PTs) through certificates, via telephones or online banks and E-banks through secure electronic communication. In alternate embodiments, notification of the secure payment system token can be through e-mail, instant messaging, SMS, or any other device capable of communicating securely with the server coordinating the electronic payment mechanism.

The electronic payment process of the present invention requires the interaction between a machine capable of communicating securely with the server computers, either directly or via a third party computer or communication networks and delivering a card, certificate or receipt. This machine could include mechanisms to read information pertaining to the electronic payment mechanism product including, but not limited to: magnetic strip, bar code, optical character recognition or digitally stored information.

Information to be communicated from the machine to the server or servers includes a Code, a Personal Identification Number (PIN), the value, the currency, the Merchant ID and the machine ID. The machine should be capable of receiving the same information plus confirmation and printing instructions.

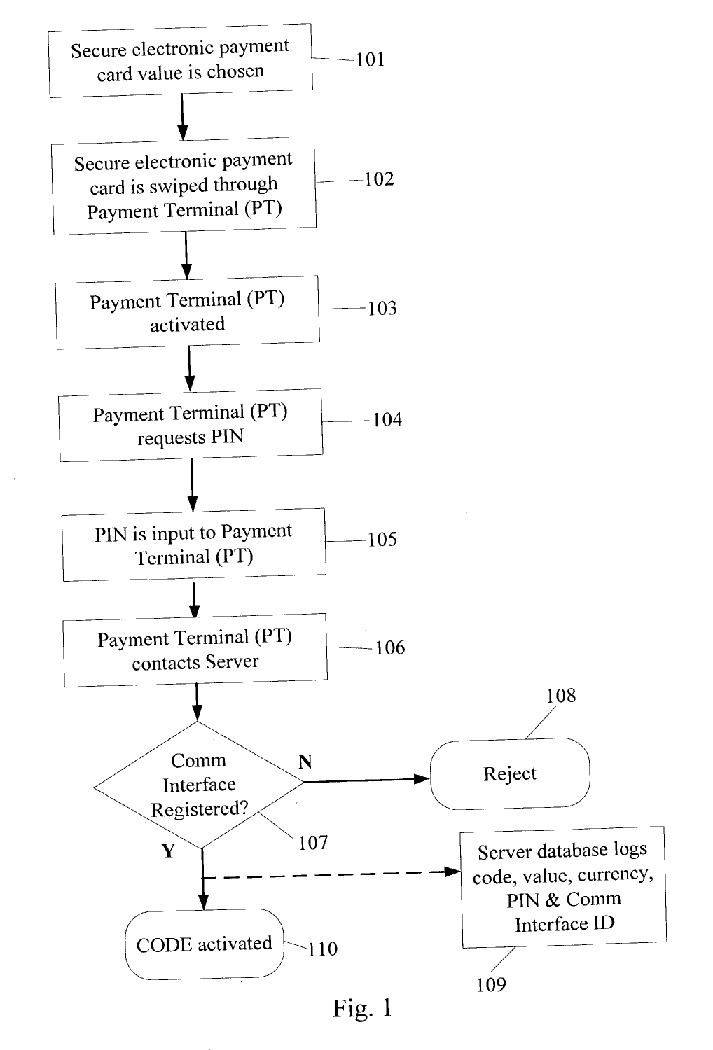

With respect to sale of a card to be used with the electronic payment mechanism, the process of purchasing such a card through a physical location, such as a bricks and mortar retailer or a reseller outlet, is illustrated in FIG. 1. The cards are dispatched to identified distributors in recorded batches and the distributor delivers batched cards to registered retailers.

The process illustrated in FIG. 1 begins with the selection of a card value for the secure electronic payment card in 101. The secure electronic payment card is then swiped through a Payment Terminal (PT) in 102 and the PT is activated in 103. It is noted that the swiping of the card may occur through a magnetic strip, a bar code, an optical character recognition system or through digitally stored information passed through wireless electronic communication medium. Additionally, the swiping may be performed by the consumer or the vendor, depending on the setup of the PT.

Thereafter, the PT requests a Personal Identification Number (PIN) from the customer, in 104, and a PIN is supplied in step 105. Next, in 106, the PT contacts the server of the secure electronic payment system and a determination of whether the communication interface providing the contact is registered with the server in step 107. Thereafter, the CODE is activated, in 110, and is available to be used in commerce.

Also, once the PIN is input and accepted, the Server is informed and the code, the value, the currency, PIN and communication interface ID are also saved in a database, in 109. While the embodiment illustrated in FIG. 1 discusses the verification that the communication interface is registered, the present invention is not so limited. Other types of connections, other than by a specific communication interface, such as connections through the Internet or other network to the server, may be verified in step 107, such that the proper registration information can be verified.

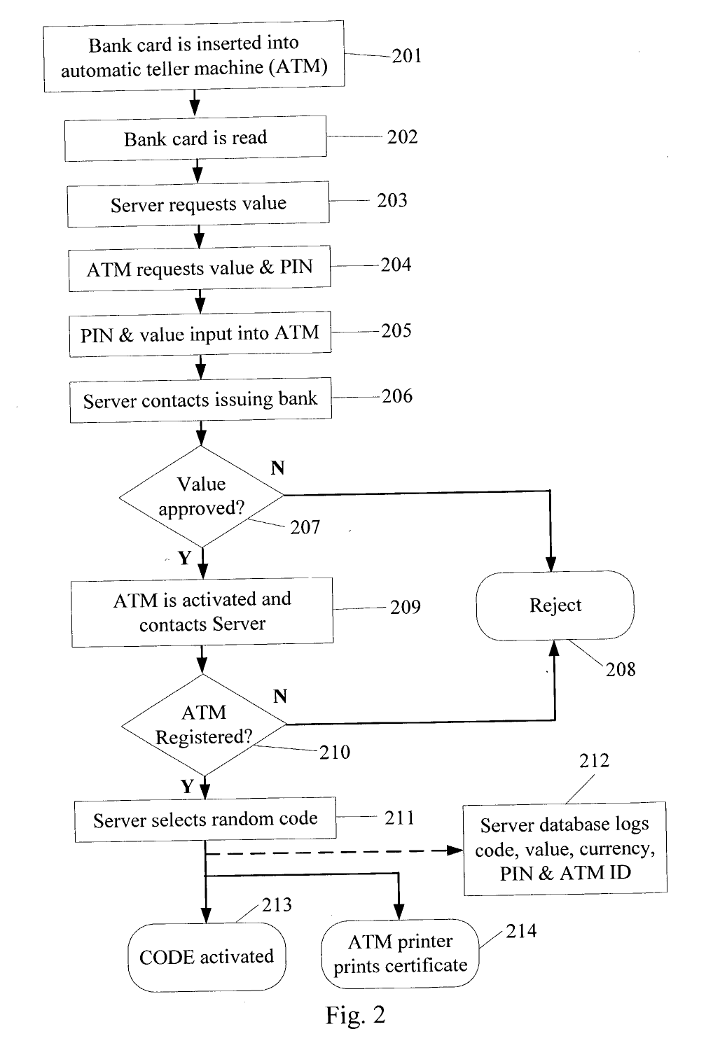

The purchase through an Automatic cash teller machine (ATM) is similar to that just discussed and is illustrated in FIG. 2. A bank card is inserted into the ATM, in 201, and the bank card is read, in 202. The process is continued and the Server requests a value, in 203, and the ATM requests the bank card user's desired value and a PIN associated with the bank card, in 204. The user then inputs the value and the PIN, in 205, and the issuing bank is contacted, in 206. Thereafter, it is determined whether the selected value is approved in 207. If the value is not approved, perhaps because of a lack of available funds or other reason, then the transaction is rejected, in 208, and the process is terminated.

Thereafter, the ATM is activated and contacts the Server that mediates the secure electronic payment system, in 209. The Server determines whether the ATM is registered with the system, in step 210, and if it is not, then the transaction is rejected, in step 208. Upon rejection, the ATM is informed and any action deemed appropriate may occur. For example, the bank card user may receive an on-screen message or receive a print out detailing that the transaction cannot be completed.

When the value is approved, the Server selects a random code, in 211, and that code is activated to use with the secure electronic payment system, in 213. Additionally, the ATM printer prints a certificate for the user, in 214. Also, server database logs the code, value, currency, PIN and ATM ID, in 212, for later verification.

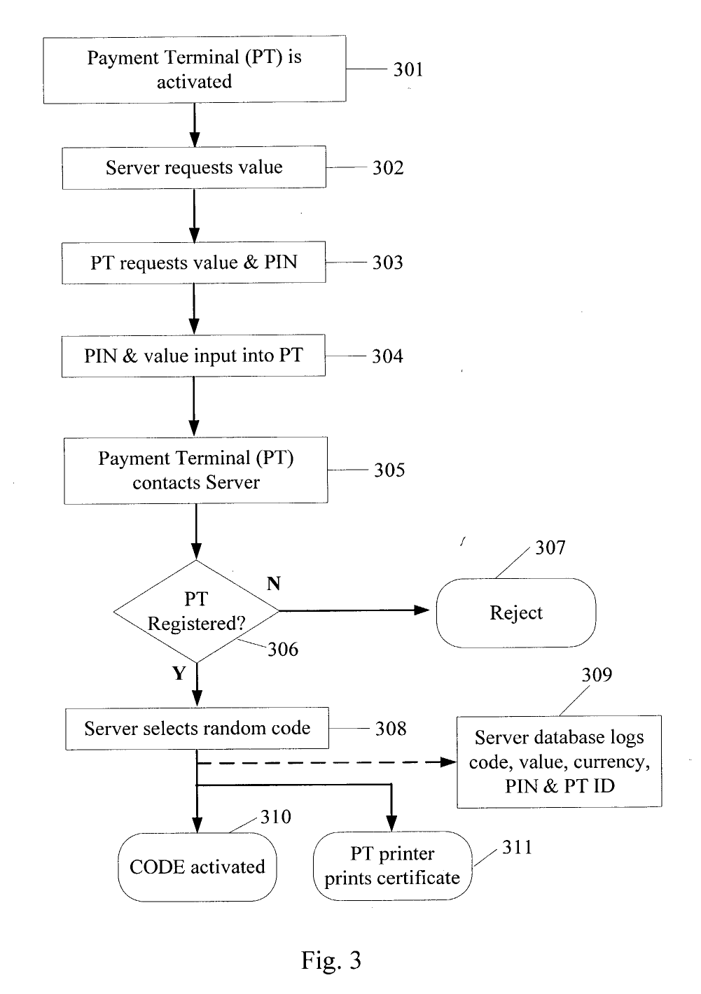

In another embodiment, the process of purchasing a certificate from a Payment Terminal (PT) is illustrated in FIG. 3. In step 301, the PT is activated. Such activation may be through swiping a card, pushing a button or buttons or some other means specific to the PT. Then, the process is continued and the Server requests a value, in 302, and the PT requests the desired value and a PIN, in 303. The user then inputs the value and the PIN, in 304, and the Server is informed.

Thereafter, the PT contacts the Server that mediates the secure electronic payment system, in 305. The Server determines whether the PT is registered with the system, in step 306, and if it is not, then the transaction is rejected, in step 307. Upon rejection, the PT is informed and any action deemed appropriate may occur. For example, the user may receive an on-screen message or receive a print out detailing that the transaction cannot be completed. The Server selects a random code, in 308, and that code is activated to use with the secure electronic payment system, in 310. Additionally, the PT printer prints a certificate for the user, in 311. Also, server database logs the code, value, currency, PIN and PT ID, in 309, for later verification.

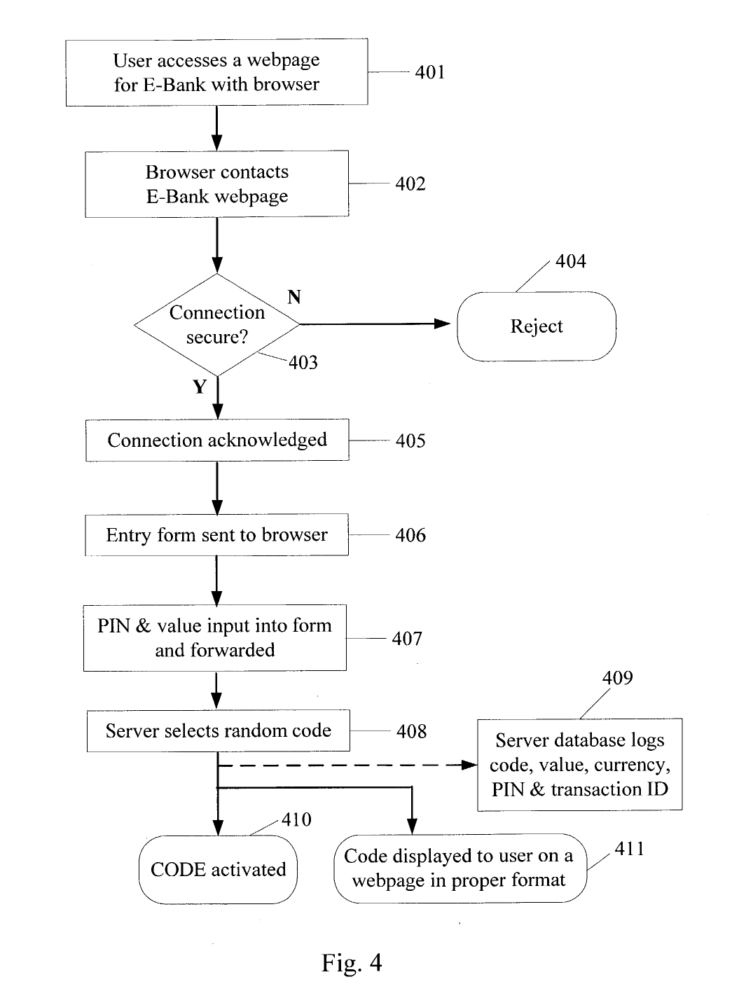

In another embodiment, the process of purchasing a certificate from an E-Bank is illustrated in FIG. 4. In step 401, a user access a webpage for the E-Bank using a web browser. Such a browser may be on a personal computer, part of a mobile telephone, or other communication device capable of secure electronic communication. Thereafter, in step 402, the user initiates a request for use of the secure electronic payment system. The Server determines whether the browser has made a secure connection, in step 403, and if it is not, then the transaction is rejected, in step 404′. Upon rejection, the browser is informed and any action deemed appropriate may occur. For example, the user may receive an on-screen message detailing that the transaction cannot be completed.

If the secure connection is made, then the process is continued and the Server acknowledges the connection, in 405, and the Server sends a data entry form to the browser that will facilitate entry of the proper data from the user, in 406. The user then inputs the desired value and the PIN, in 407, and filled-in data is forwarded to the Server. The Server selects a random code, in 408, and that code is activated to use with the secure electronic payment system, in 410. Additionally, webpage data is sent to the browser so that the code can be displayed to the user on a webpage in the proper format, in 411. Thereafter, the user may note the code or print out a copy of the webpage for later referral. Also, server database logs the code, value, currency, PIN and PT ID, in 409, for later verification.

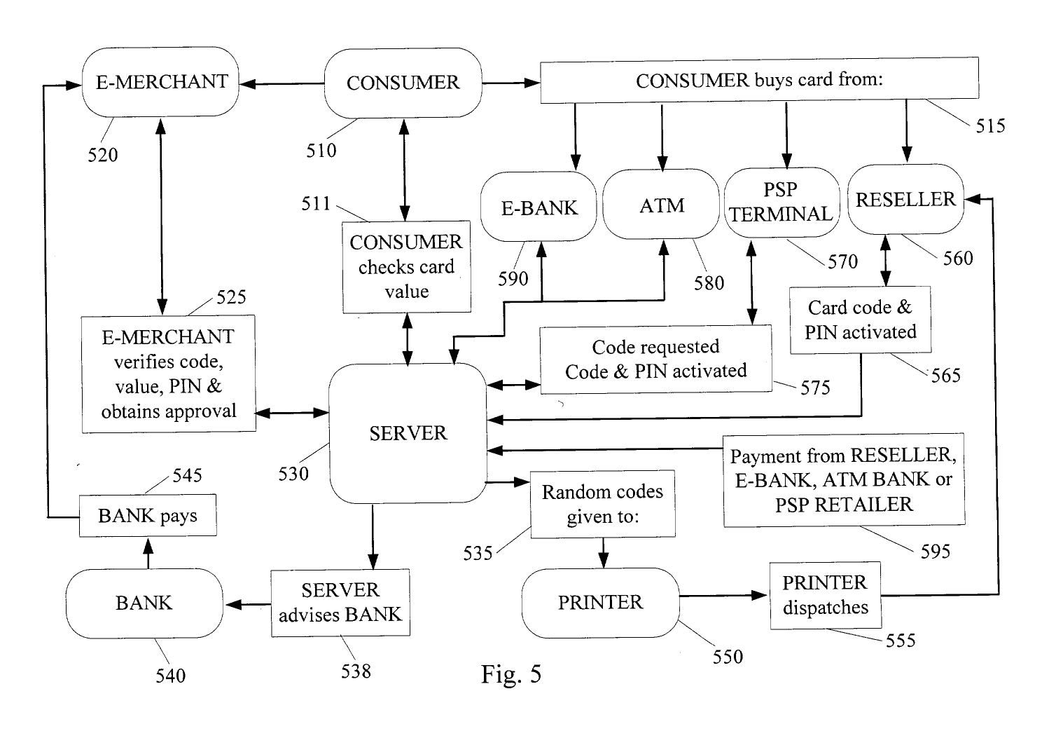

An example of the overall process, and a configuration, of the present invention is illustrated in FIG. 5. The consumer 510 wishes to engage in commerce with the E-merchant 520 and buys a card 515 that utilizes the secure electronic payment system of the present invention. The consumer can obtain the mechanism from an E-bank 590, from an ATM 580, from Payment Service Provider (PSP) 570 or a reseller 560. In the first three cases, a code is requested from the server 530 and a code and PIN are activated 575. In the case of the reseller 560, the card code and the PIN are activated 565 through the server. The server 530 provides random codes 535 that are provided to a printer 550, such that the printed information may be dispatched 555 to the consumer at the reseller 560. The consumer checks the card value 511 and interacts with the server if the value is incorrect.

When the consumer 510 engages in commerce with the e-merchant 520, the merchant verifies the code, value and the PIN and obtains approval from the server 530. Once approval is obtained, the consumer's purchase proceeds and the server 530 logs the purchase. The server 530 advises a bank 540 at 538, where the bank pays 545 the e-merchant 520 based on the consumer's purchase. In all cases, a payment 595, from the reseller, e-bank, issuing bank (for ATM distribution), or retailer (for Payment Terminal distribution), is provided to the entity providing the secure electronic payment system.

According to other embodiments of the present invention, the use of the secure electronic payment system may be facilitated via a telephone. The purchase of electronic payment mechanism via a telephone starts when the purchaser telephones a call center and the value and the currency for electronic payment mechanism is requested. Details of a debt or a credit card are provided, as well as the purchaser's e-mail address, instant messaging or SMS identifiers, or other electronic communication identifiers. After approval a code and a PIN communicated to purchaser via the provided electronic communication identifier. Thereafter the code and PIN may be used to supply payment. Similarly, the system code and PIN may be obtained from an on-line bank or E-bank. In the latter case, the purchase option is selected on the on-line bank or E-bank website, where the value & currency are also required. Then, an electronic communication identifier and a PIN used with the on-line bank or E-bank are provided; thereafter the code is communicated to purchaser via the electronic communication identifier provided. Additionally, the code may be sent back to the user through the network link that was used to establish communication with the E-bank, such as a secure link through an Internet browser, for example.

The purchase of goods or services from an e-merchant is simplified by use of the electronic payment mechanism of the present invention. The mechanism can be utilized on any registered e-merchant's web site by selecting the proper payment option. The system has the benefit that a single source can confirm and allocate funds for purchases.

Other benefits of the electronic payment mechanism of the present invention include the use of multiple cards or certificates that can be consolidated to make a single purchase. Additionally, foreign currency conversion rates can be provided if the mechanism was purchased in a currency differing from the site currency. Also, any value which is unused in a purchase will be retained with the code.

In addition, the electronic payment mechanism of the present invention provides micro-payment possibilities. Such micro-payments may be required to achieve access to materials on-line. For example, a website might require a small payment for each access to a document or music source. The use of a debit or credit card provider to keep track of such small payments is not feasible because of the high overhead associated with the transactions. With the electronic payment mechanism of the present invention, such payments can be easily monitored and charged without requiring access to a debit or credit card provider to verify each transaction.

Although the invention has been described based upon these preferred embodiments, it would be apparent to those of skilled in the art that certain modifications, variations, and alternative constructions would be apparent, while remaining within the spirit and scope of the invention. In order to determine the metes and bounds of the invention, therefore, reference should be made to the appended claims.

1. A method for providing a secure electronic payment for purchase of goods and services, comprising the steps of:
awaiting initiation by a user seeking a secure electronic payment token from a dispensing unit;
contacting a server, upon initiation by the user;
awaiting notification from the server that the dispensing unit is registered;
requesting a personal identification number from the user;
forwarding the personal identification number and a value for the secure electronic payment token to the server;
awaiting confirmation from the server; and
providing notification to the user whether a code associated with the secure electronic payment token has been activated.

2. A method as recited in claim 1, wherein the secure electronic payment token comprises a pre-printed card with an ascribed value, and said step of forwarding the personal identification number and a value for the secure electronic payment token to the server comprises forwarding the personal identification number and the ascribed value to the server.

3. A method as recited in claim 2, wherein said step of awaiting initiation by a user comprises awaiting the pre-printed card being swiped through a magnetic strip reader of the dispensing unit.

4. A method as recited in claim 2, wherein said step of awaiting initiation by a user comprises awaiting an interaction between the pre-printed card and the dispensing unit through at least one of optical bar code recognition, optical character recognition and transfer of digital information via a wireless communication mechanism.

5. A method as recited in claim 2, wherein said step of forwarding the personal identification number and a value for the secure electronic payment token to the server further comprises forwarding a currency measurement for the ascribed value, a merchant identifier and a machine identifier to the server.

6. A method as recited in claim 2, wherein the code associated with the secure electronic payment token is obtained from the pre-printed card.

7. A method as recited in claim 1, wherein the secure electronic payment token comprises a certificate, the dispensing unit is an automatic teller machine and said method further comprises requesting the value for the secure electronic payment token from the user.

8. A method as recited in claim 7, wherein said step of awaiting initiation by a user comprises awaiting an insertion of a bank card into the automatic teller machine.

9. A method as recited in claim 7, wherein said step of awaiting confirmation from the server comprises awaiting receipt of an authorization and the code associated with the secure electronic payment token from the server.

10. A method as recited in claim 9, wherein the authorization is obtained by the server from a bank associated with the bank card.

11. A method as recited in claim 7, wherein said step of providing notification to the user comprises printing the certificate with a printer contained within the automatic teller machine.

12. A method as recited in claim 7, wherein said step of forwarding the personal identification number and the requested value for the secure electronic payment token to the server further comprises forwarding a currency measurement for the requested value, a merchant identifier and a machine identifier to the server.

13. A method as recited in claim 1, wherein the secure electronic payment token comprises a certificate, the dispensing unit is a payment terminal and said method further comprises requesting the value for the secure electronic payment token from the user.

14. A method as recited in claim 13, wherein said step of awaiting initiation by a user comprises awaiting a payment indication by the user on the payment terminal.

15. A method as recited in claim 13, wherein said step of awaiting confirmation from the server comprises awaiting receipt of an authorization and the code associated with the secure electronic payment token from the server.

16. A method as recited in claim 13, wherein said step of providing notification to the user comprises printing the certificate with a printer contained within the payment terminal.

17. A method as recited in claim 13, wherein said step of forwarding the personal identification number and the requested value for the secure electronic payment token to the server further comprises forwarding a currency measurement for the requested value, a merchant identifier and a machine identifier to the server.

18. A method as recited in claim 1, wherein the dispensing unit is a telephone call center and said method further comprises requesting the value for the secure electronic payment token and bank or credit card information from the user.

19. A method as recited in claim 18, wherein said step of providing notification to the user comprises electronically providing the code associated with the secure electronic payment token to the user.

20. A method as recited in claim 1, wherein the dispensing unit is an online banking site and said method further comprises requesting the value for the secure electronic payment token and information related to an account with the online banking site from the user.

21. A method as recited in claim 20, wherein said step of providing notification to the user comprises electronically providing the code associated with the secure electronic payment token to the user.

22. A secure electronic payment system for providing a secure electronic payment for purchase of goods and services, comprising the steps of:
first awaiting means for awaiting initiation by a user seeking a secure electronic payment token from a dispensing unit;
contacting means for contacting a server, upon initiation by the user;
second awaiting means for awaiting notification from the server that the dispensing unit is registered;
requesting means for requesting a personal identification number from the user;
forwarding means for forwarding the personal identification number and a value for the secure electronic payment token to the server;
third awaiting means for awaiting confirmation from the server; and
providing means for providing notification to the user whether a code associated with the secure electronic payment token has been activated.

23. A secure electronic payment system as recited in claim 22, wherein the secure electronic payment token comprises a pre-printed card with an ascribed value and said forwarding means comprises forwarding means for forwarding the personal identification number and the ascribed value to the server.

24. A secure electronic payment system as recited in claim 23, wherein said first awaiting means comprises fourth awaiting means configured to await the pre-printed card being swiped through a magnetic strip reader of the dispensing unit.

25. A secure electronic payment system as recited in claim 23, wherein said first awaiting means comprises fourth awaiting means configured to await an interaction between the pre-printed card and the dispensing unit through at least one of optical bar code recognition, optical character recognition and transfer of digital information via a wireless communication mechanism.

26. A secure electronic payment system as recited in claim 23, wherein said forwarding means comprises forwarding means for forwarding a currency measurement for the ascribed value, a merchant identifier and a machine identifier to the server.

27. A secure electronic payment system as recited in claim 23, wherein the code associated with the secure electronic payment token is obtained from the pre-printed card.

28. A secure electronic payment system as recited in claim 22, wherein the secure electronic payment token comprises a certificate, the dispensing unit is an automatic teller machine and said system further comprises requesting means for requesting the value for the secure electronic payment token from the user.

29. A secure electronic payment system as recited in claim 28, wherein said first awaiting means comprises fourth awaiting means configured to await an insertion of a bank card into the automatic teller machine.

30. A secure electronic payment system as recited in claim 28, wherein said third awaiting means comprises fourth awaiting means for awaiting receipt of an authorization and the code associated with the secure electronic payment token from the server.

31. A secure electronic payment system as recited in claim 30, wherein the authorization is obtained by the server from a bank associated with the bank card.

32. A secure electronic payment system as recited in claim 28, wherein said providing means comprises printing means for printing the certificate with a printer contained within the automatic teller machine.

33. A secure electronic payment system as recited in claim 28, wherein said forwarding means comprises forwarding means for forwarding a currency measurement for the requested value, a merchant identifier and a machine identifier to the server.

34. A secure electronic payment system as recited in claim 22, wherein the secure electronic payment token comprises a certificate, the dispensing unit is a payment terminal and said system further comprises second requesting means for requesting the value for the secure electronic payment token from the user.

35. A secure electronic payment system as recited in claim 34, wherein said first awaiting means comprises fourth awaiting means for awaiting a payment indication by the user on the payment terminal.

36. A secure electronic payment system as recited in claim 34, wherein said third awaiting means comprises fourth awaiting means for awaiting receipt of an authorization and the code associated with the secure electronic payment token from the server.

37. A secure electronic payment system as recited in claim 34, wherein said providing means comprises printing means for printing the certificate with a printer contained within the payment terminal.

38. A secure electronic payment system as recited in claim 34, wherein said forwarding means comprises forwarding means for forwarding a currency measurement for the requested value, a merchant identifier and a machine identifier to the server.

39. A secure electronic payment system as recited in claim 22, wherein the dispensing unit is a telephone call center and said system further comprises second requesting means for requesting the value for the secure electronic payment token and bank or credit card information from the user.

40. A secure electronic payment system as recited in claim 39, wherein said providing means comprises electronic communication means for electronically providing the code associated with the secure electronic payment token to the user.

41. A secure electronic payment system as recited in claim 22, wherein the dispensing unit is an online banking site and said system further comprises second requesting means for requesting the value for the secure electronic payment token and information related to an account with the online banking site from the user.

42. A secure electronic payment system as recited in claim 41, wherein said providing means comprises electronic communication means for electronically providing the code associated with the secure electronic payment token to the user.
